(19) United States
(12) Patent Application Publication
(10) Pub. No.: US 2021/0056466 A1
(43) Pub. Date: Feb. 25, 2021

(54) SYSTEM AND METHODOLOGY FOR DATA CLASSIFICATION, LEARNING AND TRANSFER

(71) Applicant: Parsons Corporation, Centreville, VA (US)

(72) Inventors: Nicholas E. Ortyl, III, Bedford, MA (US); Samantha S. Palmer, Henrico, VA (US); Joseph Payton, Centreville, VA (US); Kyle A. Roberts, Fredericksburg, VA (US)

(73) Assignee: Parsons Corporation, Centreville, VA (US)

(21) Appl. No.: 16/996,322

(22) Filed: Aug. 18, 2020

Related U.S. Application Data
(60) Provisional application No. 62/888,810, filed on Aug. 19, 2019.
(60) Provisional application No. 62/915,977, filed on Oct. 16, 2019.

(51) Int. Cl. G06N 20/00; G06N 5/04

(52) U.S. Cl. CPC G06N 20/00; G06N 5/04

(57) ABSTRACT

Detection and classification of patterns in high speed streaming data using algorithmic learning processes creates transferable models. Synchronized local data models are housed in a data model repository and upon receiving one or more data points from a continual source of data a determination is made whether the newly collected data falls within an existing data model. If so, the detection is reported. If not the data is stored in an unknown data detection list. Clusters of the data residing in the unknown data list are formed and from those clusters statistical features extracted. An n-dimensional convex hull is fashioned bounding a region within which the statistical features lie thereby establishing a new class of data. The new class of data is, or can be, thereafter transferred to other existing models such that the receiving model can update its data model repository without performing any data analysis.

### RELATED APPLICATION

The present application relates to and claims the benefit of priority to U.S. Provisional Patent Application No. 62/888,810 filed Aug. 19, 2019 and U.S. Provisional Patent Application No. 62/915,977 filed Oct. 16, 2019 which are hereby incorporated by reference in their entirety for all purposes as if fully set forth herein.

### BACKGROUND OF THE INVENTION

### Field of the Invention

Embodiments of the present invention relate, in general, to detection and classification of data and more particularly to the processing of a continuous data stream for detection, classification and partial or complete transference of a data model.

### Relevant Background

Recognizing patterns in high speed data streams has become increasingly popular among data scientists. This data typically exhibits properties of what is known as the 6Vs of big data:
Volume: The volume of data continues to increase, but the percentage of data that current tools can process remains limited.
Variety: There are many different types of data, originating from a variety of sensor types.
Velocity: Data is arriving continuously, and a need exists to obtain information regarding such data in real time.
Variability: The structure or interpretation of the data changes over time.
Value: Data is valuable only to the extent that it leads to better decisions, and eventually a competitive advantage.
Validity: Some data may be unreliable. It is important to manage uncertainty.

In most instances a traditional, supervised learning approach is used by which large amounts of static data is input and analyzed. In such an approach a static set of data is examined to derive (i.e. train) a mathematical model capable of distinguishing between one or more categories. Such an approach utilizes a large, static corpus of data (as opposed to a more dynamic streaming data set) to perform model training. Moreover, these types of approaches are generally not performed in the environment in which the data is generated nor can the results of many such approaches be partially transferred to another classification model.

FIG. 1A is a graphical represented of data classification systems as would be known to one of reasonable skill in the relevant art. Looking at a corpus of static data a developer trains or develops 105 a data model. For example: To make a neural network recognize the difference between pictures of a cat and dog, every picture selected to train the model has to be labeled “cat” or “dog.” Labeling data is manually labor intensive and time consuming. The amount of data needed to train a model can vary drastically depending on the complexity of the problem. In many cases, a large data volume is required to form a model (for RF classification problems, this can involve gigabytes, or even terabytes of data). Collecting a massive amount of good quality training data (i.e. gathered with minimal anomalies, while covering a wide range of conditions) for Supervised Machine Learning algorithms is typically the most difficult step in the Data Science process.

This model, or these models, are presented to end users 110 (customers) to identify received signals. Invariably, not all signals received by the customer fall within the defined model. The customer turns back 120 to the suppler/developer with additional data to create a new model. The process is repeated, and the now new or updated model is reinstalled until a yet another unknown signal is observed, causing yet another request for an updated model. The process is inefficient and costly.

An online or real time learning system remains a challenge. Such a system typically refers to a technique that is capable of updating a classification model with new data, streaming data, rather than learning on an entire training set of static data all at once. What is need is an online system that allows for the data analysis to be ‘adaptive’ and ongoing so as to recognize changes in patterns of data as they occur. So called “norms” in data may change over time, a concept known as concept drift. It is desirable for an online system to possess the ability to detect and thereafter train other systems with newly discovered, novel classes of “drifted” data. Such a system would learn and identify emerging classes of data as they materialize over time rather than require a complete set of static data for renewed analysis.

Online classification systems in digital signal processing have great potential to solve many difficult problems. Most notably the learning and classification of new devices and communications protocols, with the multitude of wireless devices surrounding us every moment of every day, it is desirable to detect, learn, and classify instances of these devices without the need for continual updates to system software. But the advantages of such an approach are yet to materialize and significant challenges remain.

These and other deficiencies of the prior art are addressed by one or more embodiments of the present invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Spatially dense clusters of streaming data are detected and analyzed to identify statistically significant features. These features are compared to known n-dimensional convex hull, each representing a class of features associated with a class of data. In those instances, in which a cluster of unknown data is recognized yet not associated with any known class, a new n-dimensional convex hull can be created to capture the significant features of the cluster and thereby defining a new class of data. This new convex hull and class representation can thereafter be transferred to other detection devices so as to update their known models of data without necessitating any further analysis.

In one embodiment of the present invention a method for automated data classification is implemented by a computer. The computer is communicatively coupled to one or more continual sources of data and includes one or more processors configured to execute instructions to perform the classification. The process of the present invention begins by synchronizing a set of local data models with one or more data models housed in a data model repository to generate a synchronized set of local data classes. Each data model includes one or more classes of statistical features of data points.

With a synchronized model of classes established in each device a plurality of data points is received from the one or more continual sources of data. Each of the plurality of the received data points is tested against the synchronized set of local data classes. When the received data points match at least one of the synchronized set of local data classes, a model detection is reported along with a degree of confidence. When points fail to match at least one of the synchronized set of local data classes, the received data point is stored in an unknown detection list until sufficient numbers are accumulated form a cluster of points.

identifying an unspecified number of separable clusters of data points from data points within the unknown detection list is the next step in the process. Each cluster is comprised of a plurality of data points having a similar point density distinguishable from noise. Statistical features of the plurality of data points within the unknown detection list and within each cluster are extracted. From these extracted features an n-dimensional convex hull is formed defining a bounded region of statistical features of data points thereby establishing a new class. This region of statistical features of data points bounded by the convex hull defines a finite number of data points substantially less than the plurality of data points in the cluster yet representative of the statistical features.

Of features of the above identified methodology include associating a new class of statistical features of data points with one or more of the one or more stored data models in the data repository and synchronizing a model with stored data models, comprising loading all classes and associated convex hulls. In one embodiment the classes involve electronic signals, and the method further comprises receiving signal detections comprised of signal features within a predetermined timeframe.

The methodology of the present invention also includes generating a detection cluster from the received signal detections and their signal features, and thereafter determining whether the signal features of the detection cluster lie within a convex hull of any existing classes. When signal features of the detection cluster lie within a convex hull of any existing classes, a confidence score calculated, and a detection report generated.

When signal features of the detection cluster do not lie within a convex hull of any existing classes, the signal features are stored in a list of unknown features. The list of unknown features is periodically analyzed to determine whether a new cluster exists and, if so, calculating a convex hull for the new cluster. This new convex hull is then stored as a new yet unnamed class.

Another feature of the present invention is that the new unnamed class is amended to the existing data model as a new class. Finally, the methodology of the present invention includes transferring the new class to one or more receiving models such that a receiving model can acquire the new class to existing model without performing any data analysis itself.

A system for automated data classification is another embodiment of present invention. Such a system includes one or more data models housed in a non-transitory data model repository wherein each data model includes one or more classes of statistical features of data points. It also includes one or more continual sources of data points and a non-transitory storage medium tangibly embodying a program of instructions. These instructions include code executable by a process for synchronizing a set of local data models with the one or more data models house in the non-transitory data model repository and for receiving a plurality of data points from the one or more continual sources of data. When the received data points match at least one of the synchronized set of local data classes, the instructions include program code for reporting detection. When the received data points do not match at least one of the synchronized set of local data classes the instructions store the received data point in an unknown detection list.

The system also includes program code for identifying an unspecified number of separable clusters of data points from data points within the unknown detection list wherein each cluster is comprised of a plurality of data points having a similar point density distinguishable from noise. Instructions are also provided to extract statistical features of the plurality of data points from within the unknown detection list within each cluster and to bound a region of statistical features of data points within each cluster with an n-dimensional convex hull, establishing a new class of features. The number of data points bounded by the convex hull is substantially less than the plurality of data points in the cluster.

Another aspect of the present invention is a detection cluster generated from the received signal detections and their signal features as well as program code for determining whether the signal features of the detection cluster lie within a convex hull of any existing class. A confidence score is calculated when the signal features of the detection cluster lie within a convex hull of any existing classes causing a detection report to be generated. In an instance in which the signal features of the detection cluster do not lie within a convex hull of any existing classes the features are added to a list of unknown features. This list of unknown features is analyzed to determine whether a new cluster exists, and, when a new cluster exists, calculating a convex hull for the new cluster, and storing the new convex hull as an unnamed class.

Additional features of the aforementioned system include program code for synchronizing locally stored models with stored data models housed in a data repository, including loading all classes and associated convex hulls. Additional code of the present invention drives transfer learning wherein one or more contributing models transfers one or more classes to one or more receiving models such that a receiving model can acquire a class that is new to the receiving model without performing any data analysis itself to arrive at the model. By doing so the transfer of one or more classes comprises appending one or more convex hulls to a set of convex hulls of a receiving model.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1A shows traditional model for machine learning model development as would be known in the prior art;

FIG. 1B is a high-level depiction of a online enable machine learning system for signal detection, extraction, classification and learning according to one embodiment of the present invention;

FIG. 2 is a process schematic, according to one embodiment of the present invention, illustrating model learning and transference capabilities;

FIG. 3 presents a Radio Frequency emitter detection and classification example of the implementation of one embodiment of the present invention;

FIGS. 4 A-C provide additional detail with respect to the detection, processing, feature extraction, classification and model training of Radio Frequency signals as implemented by one embodiment of the present invention;

FIGS. 5A and 5B provide a detailed example of a feature determination and extraction process with respect to received Radio Frequency signals, as would occur with the implementation of one embodiment of the present invention in a Radio Frequency detection scenario;

FIG. 6 is a flowchart of one methodology for data detection, feature extraction, classification and model learning, according to one embodiment of the present invention;

FIG. 7 is a high-level depiction of a convex hull, according to one embodiment of the present invention;

FIG. 8 shows a model viewer user interface by which graphic representations of models and data classes can be viewed and validated by a user, according to one embodiment of the present invention;

FIG. 9 shows a model transference user interface by which a user can monitor, validate and/or direct transference of models and data classes according to one embodiment of the present invention; and

FIG. 10 is a high-level depiction of a computing device suitable for implementation of instructions and program code related to one or more embodiments of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

Detection and classification of patterns in high speed streaming data using algorithmic learning processes creates transferable models. One or more embodiments of the present invention synchronize local data models with those housed in a data model repository. Upon receiving one or more data points from a continual source of data the present invention determines whether features of the newly collected data matches or falls within an existing data model. If so, the detection is reported. If not the data, now labeled as unknown data, is stored in an unknown data detection list.

Clusters of the data residing in the unknown data list are formed and from those clusters statistical features extracted. A n-dimensional convex hull is fashioned bounding a region within which the statistical features lie thereby establishing a new class of data. The new class of data is, or can be, thereafter transferred to other existing models such that the receiving model can update its data model repository without performing any data analysis.

Embodiments of the present invention are hereafter described in detail with reference to the accompanying Figures. Although the invention has been and is to be hereafter described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. The descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

With respect to the present invention, the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The term streaming is understood to mean data that is constantly being acquired and processed by a system as opposed to intermittently introduced to a system or introduced via user-initiated actions.

The term online is understood to mean a method of machine learning in which data becomes available in a sequential order and is used to update the best predictor for future data at each step, as opposed to batch learning techniques which generate the best predictor by learning on the entire training data set at once. Online learning can be understood to mean that the machine learning process is constantly in a state of learning as data flows into it rather than a static model that is singularly trained.

The term hull or convex hull is understood to mean an smallest envelope or convex closure of a shape that contains the set of points. In a collection of points, the convex hull is the smallest set of points required to draw a boundary around all of those points.

The term model is understood to mean a predictor of either a class, or a specific value, based on a training process.

The term class is understood to mean a category/categorical label assigned to a “thing” (an object or phenomenon) based on a collection of its features. Classification is the problem of identifying to which of a set of categories (sub-populations) a new observation belongs, on the basis of a training set of data containing observations (or instances) whose category membership is known.

The term feature is understood to mean explanatory variables used to describe “things” based on observations (e.g. sensor readings) or mathematical/statistical operations based on observations. For example, for a fruit, color, texture, weight, and size might be features used for classification.

The term cluster is understood to mean a group of objects that have a certain degree of similarity as determined by a mathematical function. In a density-based clustering algorithm density is a measure of how closely the feature values are packed together. Clustering is the task of grouping a set of objects in such a way that objects in the same group (called a cluster) are more similar (in some sense) to each other than to those in other groups (clusters).

Other terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Included in the description are flowcharts depicting examples of the methodology which may be used to detect, classify and transfer patterns in high speed streaming data. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

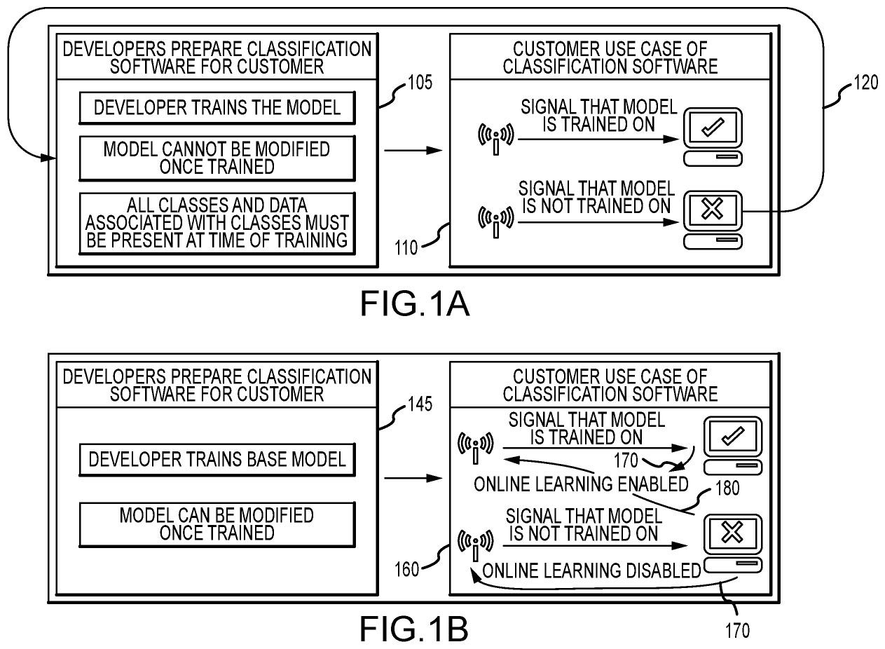

One of the features of the present invention is the ability to update or transfer learned data models from online data sources. As data is continually received, new patterns or features of the data are recognized and classified. These new classes are transferred to already existing models without the need to reexamine the entirety of the data corpus. FIG. 1B is a high-level depiction of the online learning capability of the present invention. As with most systems, the present invention begins with a database of trained 145 models. Systems 160 are initiated with these models which are used to detect and classify observed or received incoming data points. Unlike the prior art, the current invention learns 170 from those streaming data points which, though received, fail to fall within an existing model. Each system operating the current invention defines, identifies, extracts and features of these unknown data points to create 170 a new class. These new classes of data point within on or more models can thereafter be directly transferred 180 to other existing online systems. The transferee system gains the new class and updated model information without having to undergo its own analysis. The distributed system of unknown data point analysis and model transference significantly enhances the capability of each system.

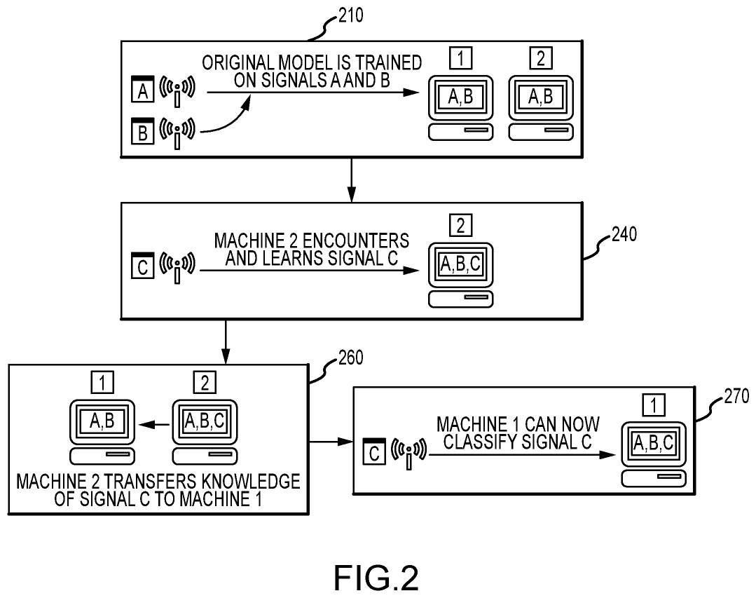

FIG. 2 provides an illustration of model transference, according to one embodiment of the present invention. Assuming for the benefit of this example that the original model stored in each data model repository is trained 210 based on signals A and B. The data model repository resident on each machine, machine 1 and machine 2 in this example, are synchronized with this initial data model so as to recognize signals A and B.

Each machine is dispersed. While machine 1 and machine 2 may receive the same signals, it is entirely possible, and even likely, that each system will receive different sources of streaming data. In this example assume machine 2, and only machine two, receives 240 a new signal, signal C. Signal C is unknown to machine 2. According to one embodiment of the present invention, machine 2 recognizes signal C as being unknown and places it in an unknown signal list. As more unknown signals are received a cluster of data points is recognized and from that cluster statistical features are extracted. A hull is formed bounding the region of statistical features establishing a new data class. Machine 2 now possesses a data model possessing three classes of signals, class A, class B and newly formed class C.

Machine 1, at this point, is unaware that class C exists. Yet, according to one embodiment of the present invention, machine 2 can transfer 260 its newly gained knowledge with respect to class C thereby modifying the model(s) resident on machine 1. Machine 1 need not examine data to come up its own classification but merely update 270 its current data model repository. In such a manner a plurality of dispersed yet communicatively coupled machines receiving disparate streams of data can receive continual updates regarding classes of data that are relevant to existing models yet not resident within their current environment.

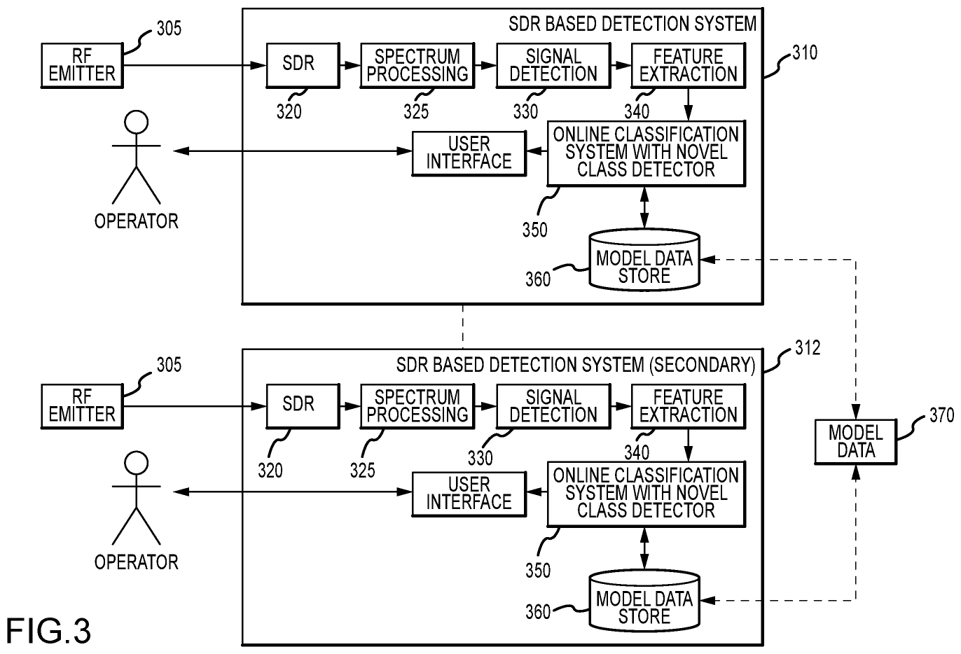

The present invention tests received streaming data against a synchronized set of data classes. In an instance in which a received data point fails to fall within a known class of data, it is stored and, as a cluster grows, analyzed to identify a new class of data. FIG. 3 is a block diagram of an embodiment of the present invention for a system for online classification and transfer learning of model data as applied to Radio Frequency (RF) data. One of reasonable skill in the relevant art will recognize that the streaming data or an otherwise source of continual data may arrive in many forms. For example, atmospheric data from various sensors or oceanographic data from buoys at sea may provide continual streams of data that may form clusters from which various data classes and models can be formed.

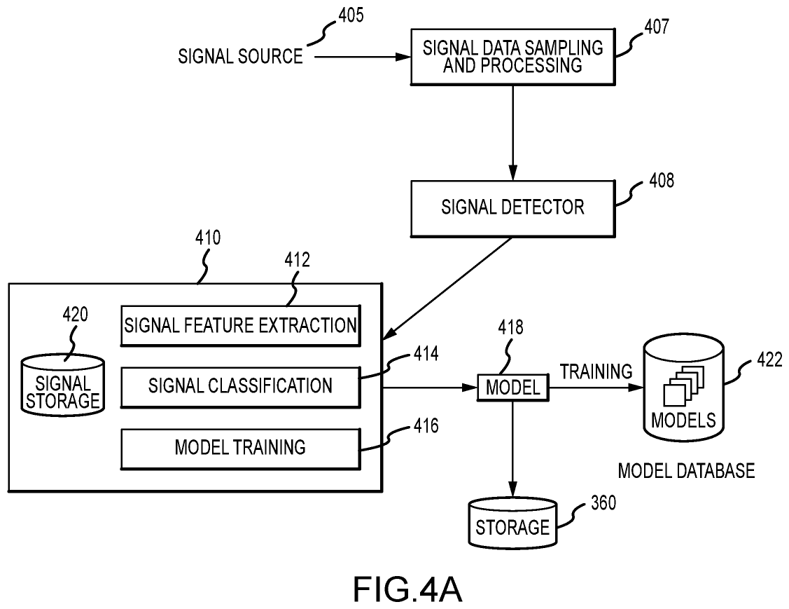

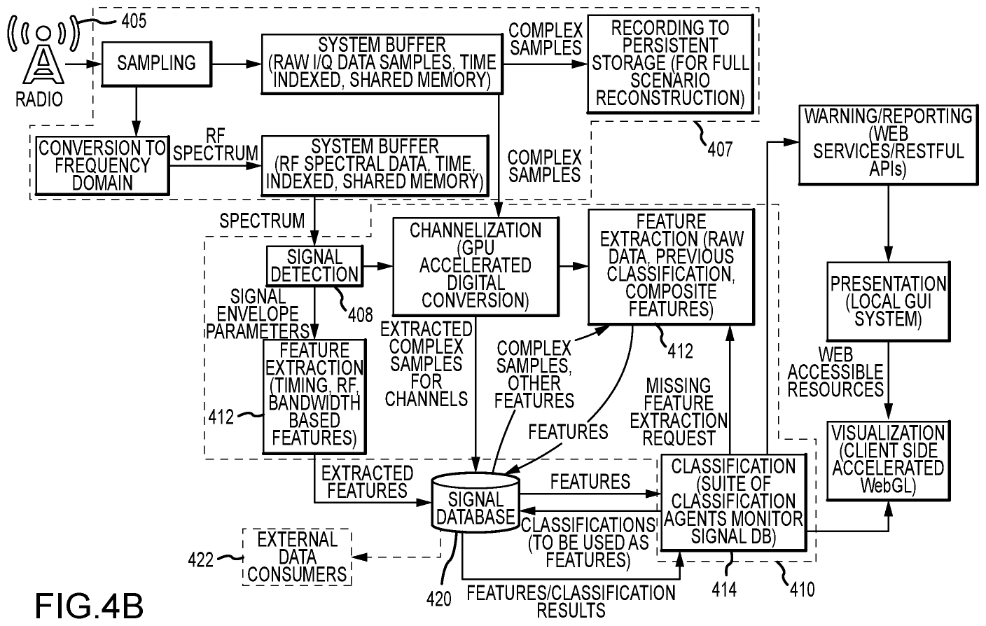

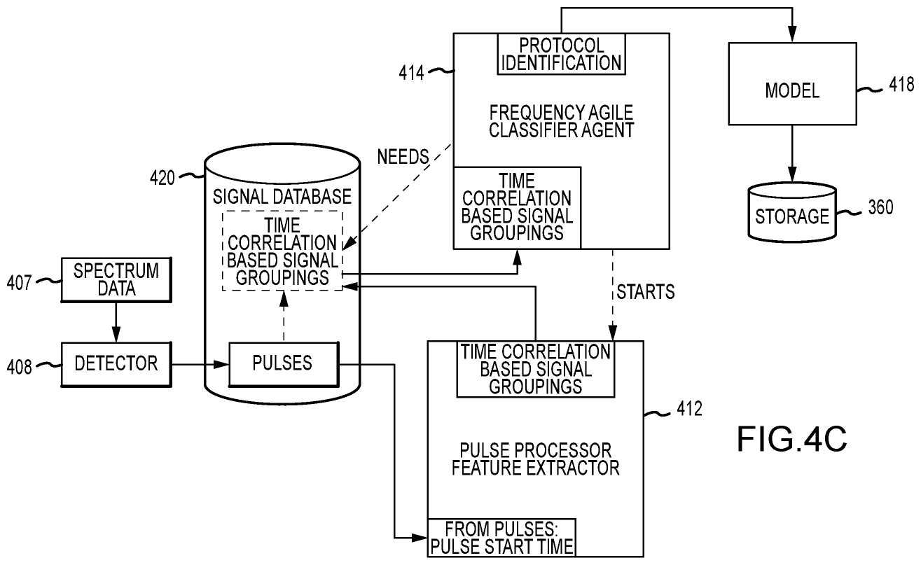

As illustrated in FIG. 3, and with additional reference to FIGS. 4 A-C, RF data from one or more emitters 305 may be received by a Software Defined Radio (SDR) signal detection system 310, 312. Upon receipt of signals (data points) by the SDR 320 the signals are sampled, conditioned, digitally filtered 325 and, in one instance converted from the time domain to the frequency domain. Raw data as well as processed data is stored to reconstruct the signals as necessary. That data is indexed, buffered, stored and otherwise spectrum processed 325. From the processed data a signal detection process 330 is applied. In one instance GPU-accelerated learning methods are applied against the FFT/spectrum data to detect signals, separating them from noise in the RF environment. After detection, GPU accelerated signal processing methods are used to extract features 340 of the narrowband signal from the main data stream employing online learning models and supervised algorithms.

The classification system and class detector 350 thereafter transform these features into actionable classes. New classes and/or model data are stored 360 which is thereafter transferred to a central data repository 370 and thereafter dispersed to other detection systems. Data class determinations achieved by one detector is shared with other similar systems.

FIG. 4A presents a high-level exemplary depiction of a signal classifier and feature extraction process. Received signals 405 are sampled, processed and examined 407 to determine if a cluster within a spatial environment exists 408. A extraction and classification system 410 thereafter extract signal features 412, classifies 414 them and forms a model class 416 using based on a n-dimensional convex hull. The model 418 is locally updated 420 and thereafter synchronized with a data model repository 422.

A more detailed depiction of signal processing, feature extraction and classification can be gained with reference to FIGS. 4B and 4C. The process with respect to RF signals begins with RF energy being captured and conditioned by a radio front end 407. After sampling and initial digital filtering stages, the radio's onboard FPGA provides both the raw samples (pre-Demodulation, enough to completely reconstruct the signals captured) and the frequency domain/FFT bins to the platform's shared memory buffers. These “raw data” buffers can be backed by any memory type within the addressable space of the system.

As the system runs, the detector uses GPU-accelerated unsupervised learning methods against the available FFT/spectrum data in order to detect signals, separating them from the noise in RF environment. After the signals are detected, the envelope parameters of the signal (start time, end time, frequency range of signal) are stored in the signal database 420. Because of the time indexed nature of the buffers the envelope parameters of these pulses (stored in the database) are sufficient to reference the raw data of the signal for further processing.

After detection 408, GPU accelerated signal processing methods are used to extract 412 the narrowband signal from the main data stream. It has been demonstrated that the present invention can achieve extraction of 100+ independent stationary signals per second, and thousands of pulses across multiple frequencies. This allows a fully stored raw digital signal to occupy a few megabytes of data rather than gigabytes leading to a reduced storage footprint for longer term storage as well as increased ease of processing. This provides system agents and feature extractors with megabytes of data to process at a time as opposed to gigabytes of data.

As shown in FIG. 4C Intelligent Classification Agents transform data elements in the database into actionable answers by employing classifiers (online learning models or pre-trained models supervised algorithms) to generate signal features. During runtime, intelligent agents monitor a signal database 420 in search of the information either from groups of RF energy pulses, or persistent long-period signals to use a classifier/regressor to formulate a data point that is needed by a system operator or by another intelligent classification agent. In cases where there is inadequate data for the agent to come to an “answer” the agent may call upon a feature extractor 412 using digital signal processing as well as statistical and unsupervised means to generate data from one or more data points. Alternatively, the agent may invoke another classification agent 414.

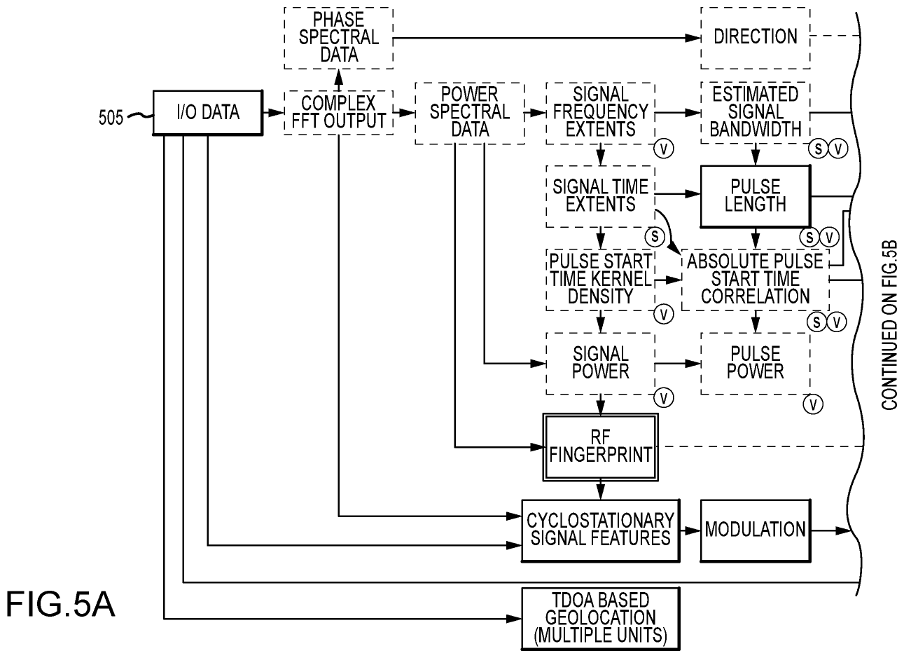

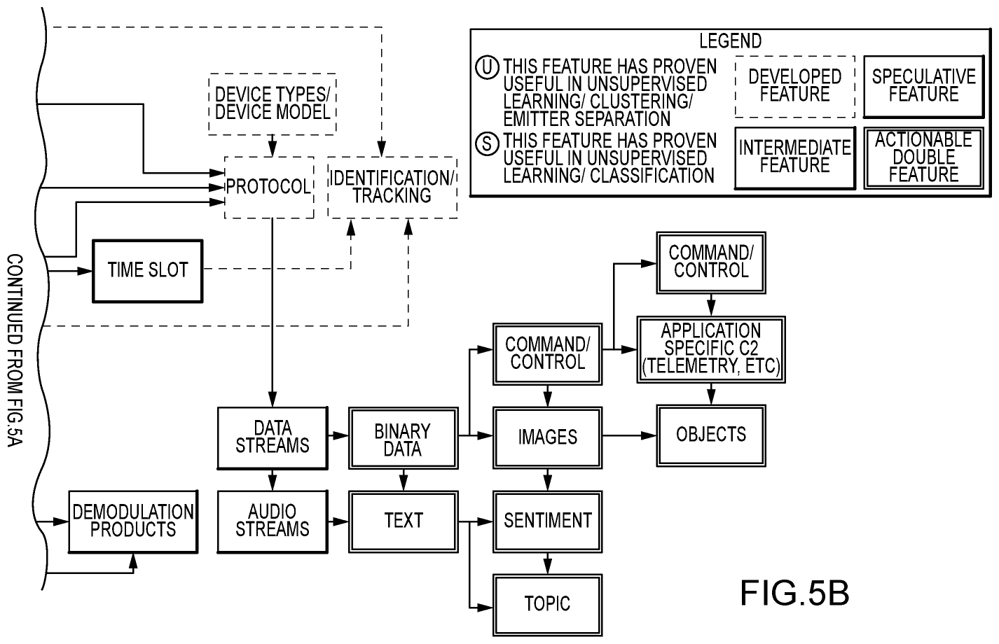

The classification agents 414 and feature extractors 412, as illustrated for a RF scenario in FIG. 5, need not be collocated. Through use of standard database technologies for the signal database instances, the system is able to scale-out beyond the capability of a single machine for the purpose of acquiring and processing signals. This enables systems and subsystems external to the original detecting and classification system to consume the data generated by the original system and in some cases, to contribute to that system improving decision-making capabilities. The classification agents 414 monitor databases, continually ensuring that they either have the data they need to perform classification tasks or that the right agents and feature extractors 412 are working to provide that data. The net result of the work of these agents is a constantly evolving picture of the RF (collected data) environment.

With respect to the above example of RF data feature extraction agents 412 focus on end stage data products (features) that are actionable while continually considering both features proven useful in supervised learning classification as well as unsupervised learning/clustering/emitter separation. In doing so actionable features can be distinguished from developed, speculative and intermediate features. Moreover, the feature extraction/determination process is not static and can self-organize to achieve intermediate stage ultimately arriving at actionable features for extraction.

FIGS. 5A and 5B provide an example of features produced by refinement and extraction of RF data. One of reasonable skill in the relevant art will recognize this depiction is exemplary and other features with respect to RF data may be omitted or included in other embodiments. Moreover, the features listed in this RF data depiction may be entirely different than those identified and extracted from a different type of data stream. While the specific features and data refinement may differ, the processes and scope of the invention remains the same. Sources of continual data 505 are collected and analyzed to determine whether they lie within a known data class as associated with a model. When data points fail to fall within such a known class, they are retained and listed as “unknown”. As a cluster of unknown data points is recognized features are identified and extracted thereby forming a new class of data, thereafter, represented by an n-dimensional hull. This new class of data model is then shared with other detection systems without those systems having to conduct any further data analysis.

Identifying features of the incoming data stream by which to recognize a cluster and then form a hull is a significant part of the present invention. And, as will be recognized by of reasonable skill in the relevant art, features of data vary for each type of data stream. Feature identification and extraction from RF data may differ significantly from streaming video. In each instance an actionable feature may be derived from an intermediate feature. The process may also be well known of proven useful in learning about certain types of data while in other instances the feature may be speculative or unproven. The present invention employs a self-learning system by which to explore, identify, creates an ultimately extract factional features from streaming data. FIGS. 5A and 5B present an exemplary process of streaming RF data feature extraction.

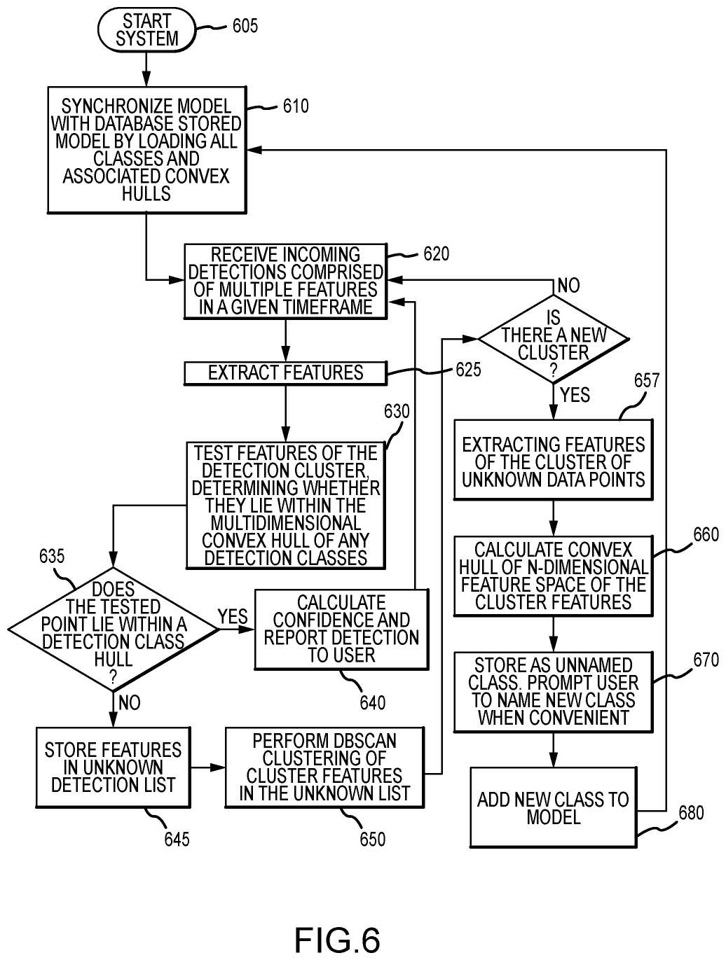

A flowchart for data detection, classification, learning and transfer according to one embodiment of the present invention is shown in FIG. 6. The process begins 605 by synchronizing 610 those data models stored in each detector or operational unit with a central or database stored model. In doing so each detector or operational unit loads all of the known data classes/models as associated with one or more convex hulls.

Data is thereafter received 620 by one or more detection systems. As previously described the present invention receives online, streaming data from various detection sources comprised of multiple features over any given timeframe. The data is processed, and statistically significant features of the data extracted 625.

From these features, clusters are recognized. In one embodiment of the present invention, a density based spatial clustering of applications with noise (DBSCAN) approach is applied find a finite number of spatially dens clusters of features in a n-dimensional space. This approach identifies groups of points (features) without directing the system to identify any certain number of groupings. Accordingly, the process can find one cluster of features or 10,000 clusters of features based on the statistical density of the features. In one embodiment of the present invention algorithms are used to find separable clusters of data and while many of the features may be assigned to a cluster there is no requirement to do so. Some of the features (points) may be labeled as noise or stored as an unknown feature (point) that may later be associated with a new cluster upon inclusion of additional data.

From the detected clusters statistical features are extracted. As previously describe, intelligent agents transform data elements into actionable features. The features are thereafter tested to determine whether they lie within an existing multidimensional convex hull of any known detection classes. A convex hull is the minimum number of points in a point cloud that can form a closed region around all of the points in that point cloud. A hull can be formed for a point cloud of any number of dimensions. The present invention uses convex hulls to represent boundaries of clusters, serving as a decision boundary for establishing class membership. The test 630 seeks to determine whether a newly found actionable feature lies within a known class bounded by a convex hull.

If the point does lie within the hull 635 a degree of confidence is determined 640 based on the proximity of the feature to the center of the hull. The closer the extracted feature is to the center the higher the confidence that the feature (data point) is associated with the class defined by the hull. Features that reside closer to the edge of a hull would produce a positive detection yet one with low confidence. To be clear, for a data point to be identified as a member of a class, the data point must possess features represented by each feature of the class (n features) as represented by the n-dimensions hull. Each feature may have a different contribution to the overall degree of confidence.

Recall that data is continually being received and analyzed. By adjusting the time frame from which data is being received additional features can be detected, extracted and clusters formed. And from that data, higher confidence may result as to whether the detections lie within a known class (hull).

When a tested feature 635 or point fails to lie within any known convex (detection class) hull it is designated as and stored 645 in an unknown point detection list. Over a sliding timeframe numerous unknown points may be detected and stored. Clustering algorithms are again employed 650 to determine whether 655 the stored unknown points form a cluster of unknown features. That is, are the points suitable persistent over a given timespan. If no clusters exist the system continues to monitor the list and periodically preform its cluster analysis. However, should a cluster be identified, a new convex hull is formed 660 to capture a feature space representative of extracted 657 features. The convex hull enables the use of the identified cluster of features without having to retain the points that define the cluster thereby reducing the model storage footprint and number of calculations necessary to determine whether a newly identified feature lies with the cluster's (hull's) boundary.

The new n-dimensional hull defines a new class of features. The unnamed class (hull) is stored 670 in the local data model repository with the user being prompted to name the new class when convenient. The newly added class is also synchronized with the database stored model 680 making it available to other detection systems upon their local synchronization.

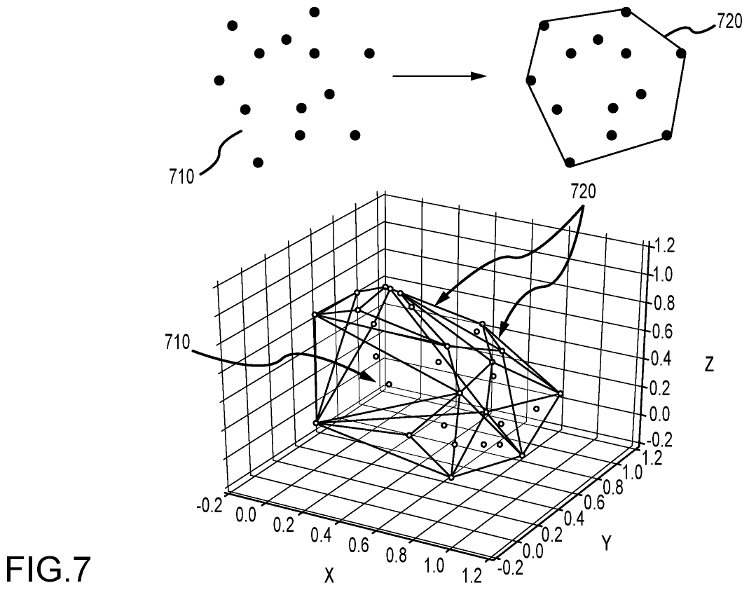

One aspect of the present invention is that each class of a model is represented by a n-dimensional convex hull rather than a corpus of data points/features. By using a convex hull, the decision by which a newly detected signal or data point lies within a model is efficient both in respect to storage and computational resources. FIG. 7 is a graphical depiction of a convex hull. The hull is a shape 720 encompassing a point cloud of data 710. Confidence that a new data point is associated with the model is based on the distances between the point and the convex hull/decision surface and the distance from the center point of the cluster of points. The hull does not encompass all points yet encompasses a statistically significant number to validate the class. Recognize that one hull can envelope another hull or that hulls can intersect.

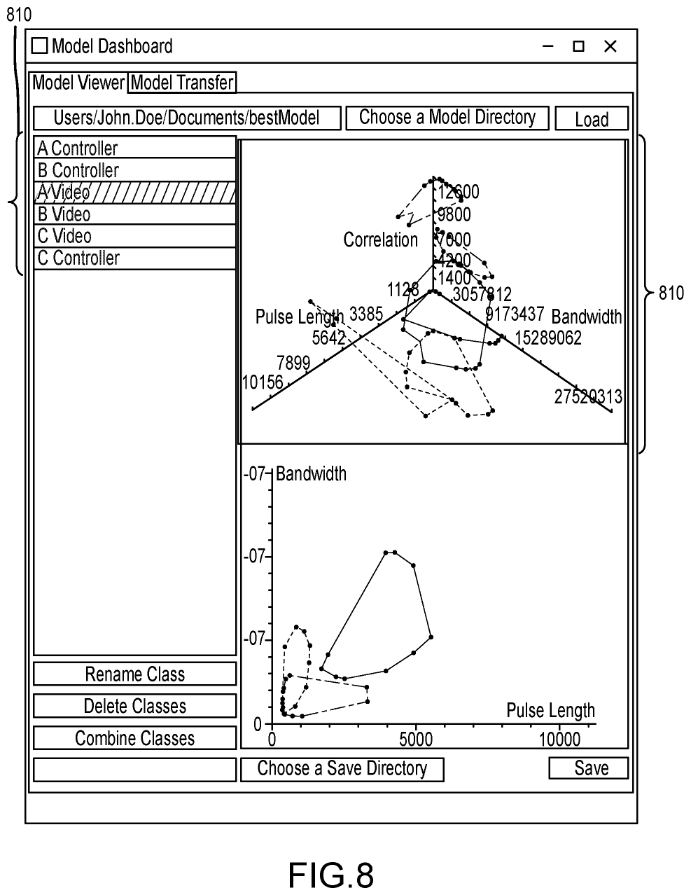

FIG. 8 is a graphical depiction of a plurality of convex hulls 810, each representing a feature class, within a particular model. As shown a list of models 820 is presented on the left column. In this instance shown the Video model is selected. On the right are a plurality of convex hulls associated with the B Video Model. Each hull represents a different class of statically significant features extracted from clusters of features.

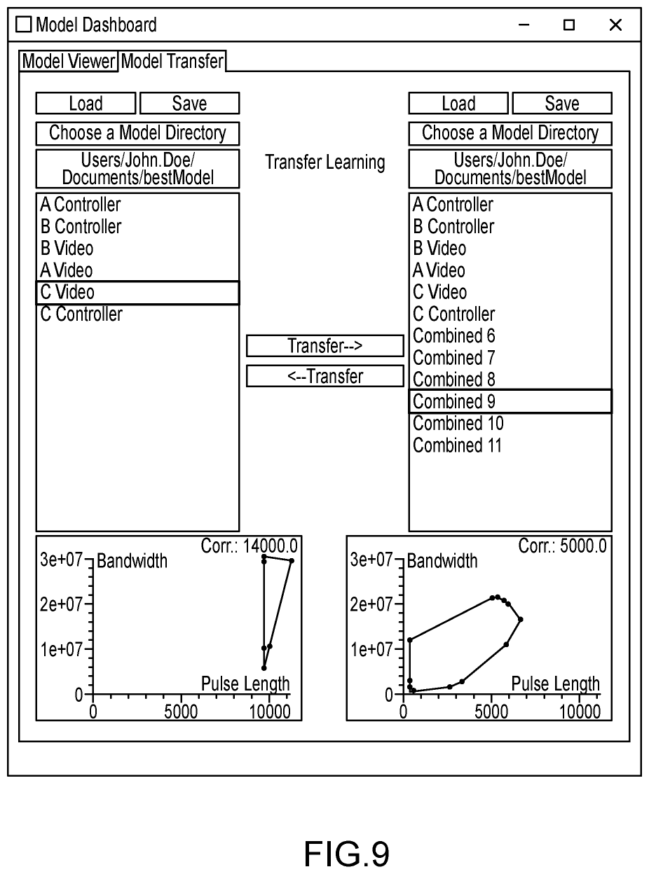

FIG. 9 provides a depiction of a user interface implementing the model transfer capability of the present invention. While the models are synchronized in a data model repository, a user can further transfer or associate various classes of data from one model to another. Thus, a set of convex hulls associated with one model can be appended to the set of convex hulls of another model.

To illustrate the novelty and applicability of the present invention consider the following example. Assume it is desirable to detect unmanned aerial vehicles (UAVs) based on radio frequency transmissions. In most instances, UAVs are controlled or interact with a ground control facility or component via certain radio frequencies. As there are numerous UAVs and their operations may overlap, various techniques are used to ensure positive control of each UAV. Yet, each transmission and interaction are unique.

A signal detection device can collect a broad spectrum of RF signals. Within these RF signals are those directed to UAVs as wells are numerous other signals and, of course, noise. According to one embodiment of the present invention a detector looking to identify UAVs would first synchronize its local repository of models with the database of stored UAV models.

As the detectors receive signals, they are processed, and clusters are recognized. Assuming a first detector identifies a cluster of signals originating from a certain azimuth and elevation over a certain timeframe. From that cluster of signals features are extracted and those features compared to known classes of stored UAVs. If the detected features lie within the n-dimensional hull defining the UAV class a detection report is generated and sent to the user. The report may indicate a certain type of UAV has been identified at a particular azimuth and elevation. With a similar report gained from a second detection, a relative location of the UAV can be determined through trilateration.

Despite the ability to identify multiple UAVs based on the stored data model repository, it is likely the model is not complete. Again, the first signal detection device identifies a cluster of signals origination at a certain azimuth and elevation. Signal features of the cluster are extracted and compared to existing models. In this instance the features do not fall within any know convex hull. Rather than discounting the signal as noise the features are store in an unknown detection list. Overtime sufficient unknown signals are stored to identify a spatially dense cluster of features. A new hull is constructed capturing and bounding the cluster space without having to store the entirety of the unknown signals.

This new unnamed class is stored in the local database identifying a new grouping of features associated, in this case, with a new UAV. The new class is also transferred to the second detector. With an updated data model for the newly identified UAV class, the second detector can quickly identify signals matching this class to establish a second determination of azimuth land elevation and therefor relative location. In doing so only the class or formed convex hull is transferred, and not the numerous unknown detection points first identified and stored by the first detection device. By doing so the transferability of the model is optimized as is the efficiency by which new data points can be compared against a new model.

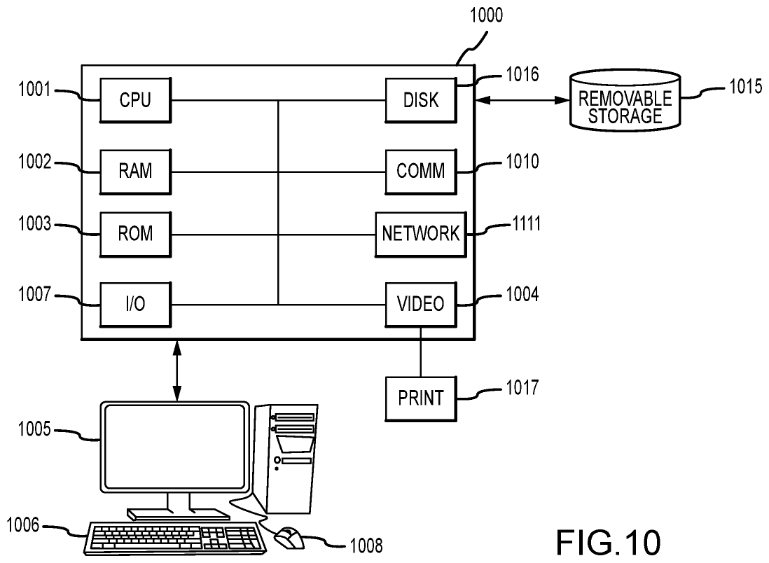

One of reasonable skill will recognize that portions of present invention may be implemented on a conventional or general-purpose computer system, such as a personal computer (PC), a laptop computer, a notebook computer, a handheld or pocket computer, and/or a server computer. FIG. 10 is a very general block diagram of a computer system in which software-implemented processes of the present invention may be embodied. As shown, system 1000 comprises a central processing unit(s) (CPU) or processor(s) 1001 coupled to a random-access memory (RAM) 1002, a read-only memory (ROM) 1003, a keyboard or user interface 1006, a display or video adapter 1004 connected to a display device 1005, a removable (mass) storage device 1015 (e.g., floppy disk, CD-ROM, CD-R, CD-RW, DVD, or the like), a fixed (mass) storage device 1016 (e.g., hard disk), a communication (COMM) port(s) or interface(s) 1010, and a network interface card (NIC) or controller 1011 (e.g., Ethernet). Although not shown separately, a real time system clock is included with the system 1000, in a conventional manner.

CPU 1001 comprises a suitable processor for implementing the present invention. The CPU 1001 communicates with other components of the system via a bi-directional system bus 1020 (including any necessary input/output (I/O) controller 1007 circuitry and other “glue” logic). The bus, which includes address lines for addressing system memory, provides data transfer between and among the various components. Random-access memory 1002 serves as the working memory for the CPU 1001. The read-only memory (ROM) 1003 contains the basic input/output system code (BIOS)—a set of low-level routines in the ROM that application programs and the operating systems can use to interact with the hardware, including reading characters from the keyboard, outputting characters to printers, and so forth.

Mass storage devices 1015, 1016 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 10, fixed storage 1016 stores a body of program and data for directing operation of the computer system, including an operating system, user application programs, driver and other support files, as well as other data files of all sorts. Typically, the fixed storage 1016 serves as the main hard disk for the system.

In basic operation, program logic (including that which implements methodology of the present invention described below) is loaded from the removable storage 1015 or fixed storage 1016 into the main (RAM) memory 1002, for execution by the CPU 1001. During operation of the program logic, the system 1000 accepts user input from a keyboard and pointing device 1006, as well as speech-based input from a voice recognition system (not shown). The user interface 1006 permits selection of application programs, entry of keyboard-based input or data, and selection and manipulation of individual data objects displayed on the screen or display device 1005. Likewise, the pointing device 1008, such as a mouse, track ball, pen device, or the like, permits selection and manipulation of objects on the display device. In this manner, these input devices support manual user input for any process running on the system.

The computer system 1000 displays text and/or graphic images and other data on the display device 1005. The video adapter 1004, which is interposed between the display 1005 and the system's bus, drives the display device 1005. The video adapter 1004, which includes video memory accessible to the CPU 1001, provides circuitry that converts pixel data stored in the video memory to a raster signal suitable for use by a cathode ray tube (CRT) raster or liquid crystal display (LCD) monitor. A hard copy of the displayed information, or other information within the system 1000, may be obtained from the printer 1017, or other output device.

The system itself communicates with other devices (e.g., other computers) via the network interface card (NIC) 1011 connected to a network (e.g., Ethernet network, Bluetooth wireless network, or the like). The system 1000 may also communicate with local occasionally connected devices (e.g., serial cable-linked devices) via the communication (COMM) interface 1010, which may include a RS-232 serial port, a Universal Serial Bus (USB) interface, or the like. Devices that will be commonly connected locally to the interface 1010 include laptop computers, handheld organizers, digital cameras, and the like.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. The invention may also be practiced in distributed computing environments where tasks are performed by remote processing devices that are linked through a communications network. In a distributed computing environment, program modules may be located in both local and remote memory storage devices.

While there have been described above the principles of the present invention in conjunction with a system and associated methodology for detection, classification, training and learning of streaming data, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for automated data classification, implemented by a computer wherein the computer includes one or more processors configured to execute instructions to perform the method and wherein the computer is communicatively coupled to one or more continual sources of data, the method comprising:
synchronizing a set of local data models with one or more data models housed in a data model repository, wherein each data model includes one or more classes of statistical features of data points, to generate a synchronized set of local data classes;
receiving a plurality of data points from the one or more continual sources of data;
testing each of the plurality of the received data points against the synchronized set of local data classes;
responsive to the received data points matching at least one of the synchronized set of local data classes, reporting detection; and
responsive to the received data points failing to match at least one of the synchronized set of local data classes, storing the received data point in an unknown detection list.

2. The method of claim 1, further comprising:
from the unknown detection list, identifying an unspecified number of separable clusters of data points from data points within the unknown detection list wherein each cluster is comprised of a plurality of data points having a similar point density distinguishable from noise;
extracting statistical features of the plurality of data points within the unknown detection list within each cluster; and
forming an n-dimensional convex hull defining a bounded region of statistical features of data points within each cluster establishing a new class, wherein the region of statistical features of data points bounded by the convex hull defines a finite number of data points substantially less than the plurality of data points in the cluster.

3. The method of claim 2, further comprising associating a new class of statistical features of data points with one or more of the one or more stored data models in the data repository.

4. The method of claim 3, further comprising synchronizing a model with stored data models, comprising loading all classes and associated convex hulls.

5. The method of claim 4, wherein the classes involve electronic signals, and wherein the method further comprises receiving signal detections comprised of signal features within a predetermined timeframe.

6. The method of claim 5, further comprising:
generating a detection cluster from the received signal detections and their signal features, and
determining whether the signal features of the detection cluster lie within a convex hull of any existing classes.

7. The method of claim 6, further comprising:
when the signal features of the detection cluster lie within a convex hull of any existing classes, calculating a confidence score; and
generating a detection report.

8. The method of claim 6, further comprising, when the signal features of the detection cluster do not lie within a convex hull of any existing classes, storing the signal features in a list of unknown features.

9. The method of claim 8, further comprising analyzing data in the list of unknown features to determine whether a new cluster exists.

10. The method of claim 9, wherein analyzing comprises performing a density based spatial clustering with noise analysis.

11. The method of claim 9, further comprising:
when a new cluster exists, calculating a convex hull for the new cluster; and
storing the new convex hull as an unnamed class.

12. The method of claim 11, further comprising adding the unnamed class as a new class to the data model.

13. The method of claim 1, further comprising a transfer learning process comprising:
one or more contributing models transferring one or more classes to one or more receiving models such that a receiving model can acquire a class that is new to the receiving model without performing any data analysis itself to arrive at the model.

14. The method of claim 13, wherein transferring classes comprises appending one or more convex hulls to a set of convex hulls of a receiving model.

15. A system for automated data classification, comprising:
one or more data models housed in a non-transitory data model repository wherein each data model includes one or more classes of statistical features of data points;
one or more continual sources of data points;
a non-transitory storage medium tangibly embodying a program of instructions; and
one or more processors configured to execute the program of instructions for automated data classification, wherein said program of instruction include,
program code for synchronizing a set of local data models with the one or more data models house in the non-transitory data model repository,
program code for receiving a plurality of data points from the one or more continual sources of data,
responsive to the received data points matching at least one of the synchronized set of local data classes, program code for reporting detection, and
responsive to the received data points failing to match at least one of the synchronized set of local data classes, program code for storing the received data point in an unknown detection list.

16. The system for automated data classification according to claim 15, further comprising:
program code for identifying an unspecified number of separable clusters of data points from data points within the unknown detection list wherein each cluster is comprised of a plurality of data points having a similar point density distinguishable from noise;
program code for extracting statistical features of the plurality of data points from within the unknown detection list within each cluster;
program code for forming an n-dimensional convex hull bounding a region of statistical features of data points within each cluster establishing a new class wherein a finite number of data points substantially less than the plurality of data points in the cluster defined by the region of statistical features of data points is bounded by the convex hull.

17. The system for automated data classification according to claim 16, wherein a new class of statistical features of data points is associated with one or more of the one or more stored data models in the data repository.

18. The system for automated data classification according to claim 17, further comprising program code for synchronizing the new class with stored data models, including loading all classes and associated convex hulls.

19. The system for automated data classification according to claim 18, wherein the classes involve electronic signals, and further comprising program code for receiving signal detections comprised of signal features within a predetermined timeframe.

20. The system for automated data classification according to claim 19 further comprising a detection cluster generated from the received signal detections and their signal features, and
program code for determining whether the signal features of the detection cluster lie within a convex hull of any existing classes.

21. The system for automated data classification according to claim 20 further comprising program code for calculating a confidence score when the signal features of the detection cluster lie within a convex hull of any existing classes and thereafter generating a detection report.

22. The system for automated data classification according to claim 20 further comprising program code for storing the signal features in a list of unknown features when the signal features of the detection cluster do not lie within a convex hull of any existing classes.

23. The system for automated data classification according to claim 22 further comprising program code for analyzing data in the list of unknown features to determine whether a new cluster exists, and, when a new cluster exists, calculating a convex hull for the new cluster, and storing the new convex hull as an unnamed class.

24. The system for automated data classification according to claim 23, further comprising program code for adding the unnamed class as a new class to the data model.

25. The system for automated data classification according to claim 15 further comprising program code for transfer learning wherein one or more contributing models transfers one or more classes to one or more receiving models such that a receiving model can acquire a class that is new to the receiving model without performing any data analysis itself to arrive at the model.

26. The system for automated data classification according to claim 25 wherein the transfer of one or more classes comprises appending one or more convex hulls to a set of convex hulls of a receiving model.
